(19) United States
(12) Patent Application Publication
(10) Pub. No.: US 2010/0178150 A1
(43) Pub. Date: Jul. 15, 2010

(54) ELEVATOR BELT INSTALLATION ASSEMBLY AND METHOD OF INSTALLING A BELT

(76) Inventors: Richard N. Fargo, Plainville, CT (US); Alicia Hayter, Avon, CT (US)

Correspondence Address: CARLSON GASKEY & OLDS, 400 W MAPLE STE 350, BIRMINGHAM, MI, 48009, US

(21) Appl. No.: 12/377,202

(22) PCT Filed: Aug. 16, 2006
(86) PCT No.: PCT/US06/31925

§ 371 Date: Feb. 11, 2009

(51) Int. Cl. B66C 1/44; B66C 1/42; B66B 7/06

(52) U.S. Cl. 414/800; 294/99.1; 294/87.1

(57) ABSTRACT

A tool for hoisting a coated steel belt of an elevator system that includes a back plate to which a plurality of clamp assemblies is mounted. Each of the clamp assemblies includes a clamp plate biased by a biasing member to resiliently secure each of the belts.

### FIELD OF THE INVENTION

This invention generally relates to elevator systems. More particularly this invention relates to a tool for hoisting and installing belts in an elevator system.

### DESCRIPTION OF THE RELATED ART

Elevator systems utilize roping to support and move a passenger car and counterweight. Various roping configurations are known including steel ropes and flat belts. Multiple ropes or belts are used for each elevator car. The ropes are threaded through a drive sheave and sometimes one or more idler sheaves depending on the specific elevator system configuration.

Installation of the ropes or belts requires lifting and aligning several relatively heavy ropes or belts. U.S. Pat. No. 6,533,077 discloses a typical example of current methods for installing roping for an elevator system. An end of several belts or ropes is clamped between two plates held together with, threaded fasteners. The threaded fasteners are tightened to apply clamping pressure to the belts. A hoist cable is then attached to the clamped plates and the belts are manipulated as necessary within the hoistway.

Disadvantageously, the use of threaded fasteners does not provide a means of controlling a pressure across the set of roping or belts. As appreciated, excessive force on the roping or belts can cause damage, and too little force may allow a belt to slip out of the clamp during hoisting. Additionally, prior art devices are attached to the ends of a belt preventing desired installation or connection while within the hoisting tool. Further, longer lengths of coated steel belts are required for certain high rise building applications. The longer lengths include an accompanying increase in weight that makes current methods of hoisting coated steel belts impractical.

Accordingly, it is desirable to design and develop a method and tool for hoisting belts during installation that will not cause damage while holding each belt in a desired position.

### SUMMARY OF THE INVENTION

In general terms, a disclosed example of an elevator belt hoisting tool applies a controlled pressure to retain each belt during hoisting and installation.

The disclosed example hoisting tool includes a base plate to which is mounted a single, or a plurality of clamps. The number of clamps corresponds to the number of belt ends that are to be secured to the hoisting tool. Further, each clamp includes a clamping plate that is biased toward the base by a biasing member. A desired pressure is controlled and applied by the biasing member and not by torque applied to mount the clamping plate relative to the base plate. In this way, the pressure utilized to retain the belt is controlled such that sufficient pressure is utilized to retain the belt but excessive pressure that could cause damage to the belt is not applied.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 is a schematic view of an elevator hoistway where belts are being installed.

FIG. 2 is a schematic view of an example hoisting tool.

FIG. 3 is a sectional view of an example clamp of the hoisting tool.

FIG. 4 is another sectional view of the example clamp.

### DETAILED DESCRIPTION OF THE PREFERRED EMBODIMENTS

Referring to FIG. 1, an elevator system 10 includes a car 12 that is supported and movable within a hoistway 15. The car 12 is movable in a known manner. A plurality of belts 20 support the passenger car 12 and a counter weight 14. The example belts 20 follow a path around a drive sheave 16 and a plurality of lower sheaves 18. Ends of the belts 20, in this example are secured using known terminations 19. The belts 20 are of such a weight and magnitude that it is not practical to hold or align the belts manually during installation.

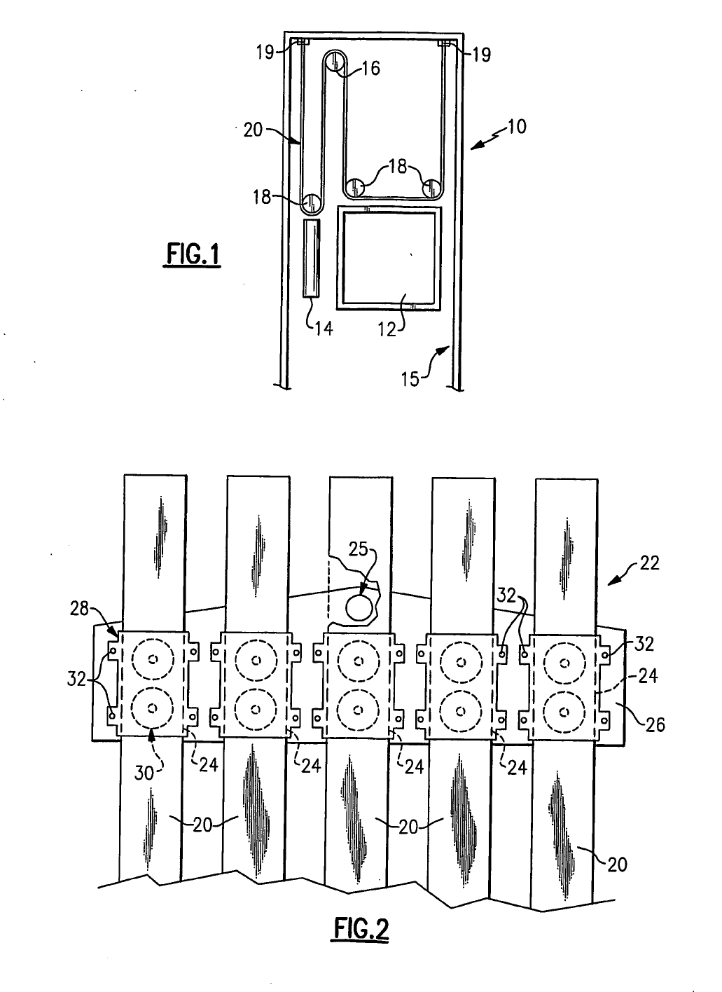

As shown in FIG. 2, a hoisting tool 22 is utilized and includes a plurality of clamps 24 that hold each of the belts 20 providing for hoisting and aligning in a uniform manner all the belts 20 together to ease installation and provide the required hoisting capability for belts 20 of various weights and lengths. This example clamps five belts 20.

The example hoisting tool 22 includes the plurality of clamps 24 that each includes a housing 28. Each of the clamps 24 are mounted over a belt 20 that is laid over the back plate 26. The housing 28 is secured to the plate 26 by a plurality of mounting fasteners 32. As the mounting fasteners 32 are tightened to the back plate 26, a biasing force is exerted on the belts 20.

However, this biasing force is not controlled by the mounting fasteners 32 but instead is controlled by a plurality of Belleville washers 30 disposed within the housing 28. Securing the housing 28 to the back plate 26 only causes the Belleville washers 30 to resiliently secure the belt 20 such that the controlled desired pressure can be applied. This biasing force applied by the Belleville washers is controlled to provide the desired pressure required to retain the belt 20 without causing damage.

Referring to FIG. 3, a single clamp 24 is shown with the clamp housing 28 cut away to show a cavity 38 that holds a plurality of Belleville washers 30. The Belleville washers 30 provide the desired clamping force on the belt 20 with little deformation such that a desired pressure may be applied to the belt 20 without causing damage. The Belleville washers 30 are stacked within the cavity 38 in numbers determined to provide the desired retention pressure on each of the belts 20. The number and orientation of the Belleville washers 30 may be changed to accommodate belts 20 of different weights and thicknesses. Although Belleville washers 30 are shown in the example, a single biasing member or resilient material may also be utilized to provide the desired controlled bias pressure to retain the belt 20.

The Belleville washers 30 are retained within the cavity 38 between the housing 28 and a clamping plate 36. The clamping plate 36 is movable to apply pressure on the belt 20. The clamping plate 36 distributes the force exerted by the Belleville washers 30 over a large area of the belt 20 thereby providing a consistent even pressure to hold the belt 20 and reduce the possibility of potential damage to the belt 20. The clamping plate 36 is movably held in place by a pair of guide members 34. The guide members 34 are attached to the clamping plate 36 on one end and extend upwardly through the Belleville washers 30 and an opening within the housing 28.

The guide members 34 move with the clamping plate 36 to provide a visual indication of the pressure applied to the belt 20. When no belt is disposed within the clamp 24 the clamping plate 36, and the guide members 34 are closer to the back plate 26 (e.g. in a lower position according to the figure). The guide members 34 also retain the Belleville washers 30 when the clamp 24 is removed from the back plate 26. With the belt 20 within the clamp housing 28 the ends of guide members 34 protrude further out of the clamp housing 28.

At least one surface of the clamping plate 36 or the back plate 26 can include a knurled surface to increase friction between the belt 20 and the clamping plate 36. The example back plate 26 includes a clamping surface 40 that includes a knurled surface. The increase in friction against the belt 20 aids in retention of the belt 20 and can be of any configuration known to a worker skilled in the art.

The Belleville washers 30 in this example are disposed in a pair of longitudinally arranged stacks within the clamp 24. Each stack consists of Belleville washers 30 of a diameter approximately equal to the width of one of the belts 20. This sizing of the Belleville washers 30 provides an even distribution of clamping pressure along a desired width and length of the belt 20. The width of the Belleville washers 30 along with the number of Belleville washers 30 may be adjusted to accommodate application specific requirements.

The housing 28 may be elongated such that three or more stacks of Belleville washers 30 can be utilized to increase the force and area over which pressure is applied to retain the belt 20 within the hoisting tool 22. Further, the specific number of Belleville washers 30 disposed within each stack can be adjusted to increase or decrease the amount of pressure applied to any of the belts 20 to accommodate application specific requirements and belts of different thicknesses and weight.

Further, the example housing 28 includes several stacks of Belleville washers 30, however, other combinations and configurations of biasing members can be utilized that would require only a single biasing member or single group of biasing member.

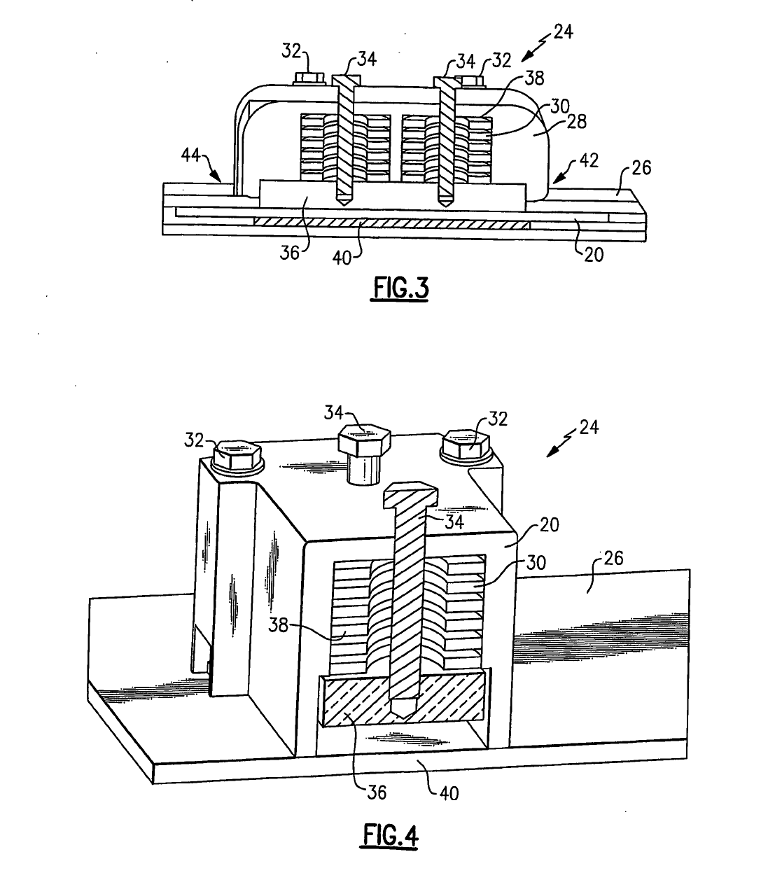

Referring to FIG. 4, the clamp 24 is shown in a different sectional view to illustrate the configuration of the housing 28 and cavity 38. A stack of Belleville washers 30 is shown biasing the clamping plate 36 toward the back plate 26. The housing 28 is configured with two stacks of Belleville washers 30 arranged longitudinally (e.g. parallel to a length of the belt 20). The backing plate 26 includes the knurled clamping surface 40 to increase friction to hold the belt 20. The clamping surface 40 may also include a coating or other means for increasing friction between the belt 20 and the back plate 26. Further, the clamping plate 36 may also include a treated or knurled surface to increase friction required to hold the belt 20 within the clamp.

Referring to FIG. 2, in operation a plurality or single belts 20 are laid over the back plate 26 with a free length extending from an opposite side. This allows for keeping the belts 20 clamped while securing one end in a termination, for example. One of the clamps 24, each including the plurality of Belleville washers 30 is placed over each belt 20 and attached to the back plate 26 by mounting fasteners 32. As the mounting fasteners 32 are tightened, the Belleville washers 30 apply the desired pressure to retain the belts. 20. The pressure cannot be increased or decreased by over-tightening the mounting fasteners 32. As the housing 28 bottoms out against the back plate 26, the preselected spring arrangement establishes the maximum pressure against a belt 20. Once all of the belts 20 have been clamped to the hoisting tool 22, a cable or other line is attached to the opening 25. The hoisting tool 22 is then manipulated through the hoistway (e.g. raised and lower to desired positions and around sheaves as needed) until the free end of each of the belts 20 is secured in a corresponding hitch or termination.

The example hoisting tool described in this disclosure provides for the consistent application of retention pressure to each of a plurality of belts to prevent potential application of damaging forces, while providing for reliable hoisting of belts of increased weights and lengths. Having free ends of the belts beyond the clamp allows for keeping belts 20 securely clamped until secured in a termination. This provides the advantage of avoiding dropped belts as a clamp is loosened or a belt is removed from a clamp. The disclosed example has no “free” or “lose” components, which avoids parts dropping in a hoistway. This saves labor time and enhances installation economies and convenience.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-18. (canceled)

19. An elevator belt installation assembly comprising:
a first member;
a housing securable to the first member;
a second member supported within the housing and movable relative to the first member; and
a biasing member supported within the housing and providing a biasing force for securing a portion of an elevator belt between the first member and the second member.

20. The assembly as recited in claim 19, including a mounting fastener for mounting the housing to the first member.

21. The assembly as recited in claim 20, wherein the biasing member provides the biasing force for securing a portion of the elevator belt independent of any force exerted by the mounting fastener mounting the housing to the first member.

22. The assembly as recited in claim 20, wherein the biasing member comprises a plurality of Belleville washers that exert a desired force on the elevator belt upon attachment of the housing to the first member.

23. The assembly as recited in claim 19, wherein the biasing member comprises a first set of biasing members and a second set of biasing members.

24. The assembly as recited in claim 23, wherein each of the first set of biasing members and the second set of biasing members provide a substantially similar clamping force on the elevator belt upon mounting of the housing to the second member.

25. The assembly as recited in claim 24, wherein the first set of biasing members and the second set of biasing members are aligned longitudinally along the elevator belt.

26. The assembly as recited in claim 19, including a guide member attached to the second member and extending through the plurality of biasing members and through an opening in the housing for providing a visual indication of a position of the second member.

27. The assembly as recited in claim 26, wherein at least one of the first member and the second member includes a knurled surface.

28. The assembly as recited in claim 19, including a plurality of housings and second members mountable to the first member and a corresponding plurality of biasing members providing a biasing force for securing a portion of an elevator belt between the first member and the second member.

29. The assembly as recited in claim 28, wherein the elevator belts are secured to both a front and back of each of the plurality of second members.

30. The assembly as recited in claim 19, wherein the first member includes a connector portion to which a hoisting cable may be secured.

31. A method of installing a belt for an elevator system comprising the steps of:
a) resiliently securing at least one belt on a first member by securing a housing supporting at least one biasing member over the at least one belt to the first member; and
b) hoisting the first member through a hoistway to move the at least one belt into a desired position.

32. The method as recited in claim 31, including the step of providing a free end of belt above the first member with a remainder of the belt length below the first member; and securing the free end within a termination.

33. The method as recited in claim 32, including the step of subsequently removing the belt from the first member.

34. The method as recited in claim 33, including the step of biasing a second member toward a first member for resiliently securing the at least one belt.

35. The method as recited in claim 34, including the step of terminating an end of the at least one belt while resiliently secured to the first member.
